(19) United States
(12) Patent Application Publication
(10) Pub. No.: US 2007/0184333 A1
(43) Pub. Date: Aug. 9, 2007

(54) Electrode for fuel cell, method of preparing the same, and fuel cell employing the same

(75) Inventors: Hyo-rang Kang, Anyang-si (KR); Myung-dong Cho, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/647,177

(22) Filed: Dec. 29, 2006

(30) Foreign Application Priority Data
Feb. 8, 2006 (KR) 2006-12031

(51) Int. Cl. H01M 4/86; H01M 4/88; B05D 5/12

(52) U.S. Cl. 429/42; 429/44; 427/115; 502/101

(57) ABSTRACT

An electrode for a fuel cell, a method of preparing the same, and a fuel cell employing the same. More particularly, provided are an electrode for a fuel cell, including a catalyst layer including a supporting material, a catalyst, and a binder, wherein the specific surface area of the supporting material is at least 500 m²/g, and wherein the binder includes an amount of fluorinated ethylene propylene copolymer in the range of 0.5 to 50 parts by weight based on 100 parts by weight of the total amount of the supporting material and the catalyst, a method of preparing the same, and a fuel cell employing the same. The electrode has superior water repellency even when a relatively small amount of binder is used compared to a conventional electrode, and as a result, efficiency of a supported catalyst is maximized.

### CROSS-REFERENCE TO RELATED APPLICATIONS

This application claims the benefit of Korean Application No. 2006-12031, filed Feb. 8, 2006, in the Korean Intellectual Property Office, the disclosure of which is incorporated herein by reference.

### BACKGROUND OF THE INVENTION

1. Field of the Invention

Aspects of the present invention relate to an electrode for a fuel cell, a method of preparing the same, and a fuel cell employing the same, and more particularly, to an electrode for a fuel cell having superior water repellency even when a relatively small amount of binder is used compared to a conventional electrode, resulting in maximized efficiency of a supported catalyst, a method of preparing the same, and a fuel cell employing the same.

2. Description of the Related Art

Fuel cells are electricity generation systems that directly convert the chemical energy of oxygen, and hydrogen in hydrocarbons, such as methanol, ethanol, and natural gas, to electrical energy. Fuel cells can be classified into proton exchange membrane fuel cells (PEMFCs), phosphoric acid fuel cells (PAFCs), molten carbonate fuel cells (MCFCs), solid oxide fuel cells (SOFCs), etc. according to the type of electrolyte used. The working temperature of fuel cells and constituent materials thereof vary according to the type of electrolyte used in the fuel cells.

A stack in a fuel cell, which generates electricity, comprises a plurality (several to several tens) of unit cells each including a membrane electrode assembly (MEA) and a separator (or bipolar plate). In the MEA, an anode electrode and a cathode electrode adhere closely to each other, wherein a polymer electrolyte membrane is interposed between the anode electrode and the cathode electrode.

The anode electrode and the cathode electrode each include a catalyst layer and a diffusion layer. Oxidation/reduction reactions are performed in the catalyst layers, and the catalyst layers are prepared by binding a supported catalyst impregnated with a catalyst metal with a binder.

A polybenzimidazole (PBI) based polymer is mostly used as the electrolyte membrane of a PEMFC operating at a high temperature. Such an electrolyte membrane has superior chemical stability and ionic conductivity. However, when the electrolyte membrane contains excessive phosphoric acid, polybenzimidazole dissolves in the phosphoric acid. Accordingly, polybenzimidazole is chemically treated with polytetrafluoroethylene before using polybenzimidazole as an electrolyte membrane. In this case, an electrode should be hydrophobic, otherwise phosphoric acid in the electrolyte membrane will escape to generate crossover.

Consequently, research on hydrophobic coating on an electrode has been performed, and Japanese Patent Laid-Open Publication Nos. 1979-095982, 1982-208072, 1988-048752, etc., disclose using polytetrafluoroethylene as a binder while preparing an electrode.

However, when excessive polytetrafluoroethylene binder is used for hydrophobic coating, a specific surface area of a supported catalyst is reduced, cell resistance of an electrode is increased, and crossover may increase because desired water repellency is not obtained.

### SUMMARY OF THE INVENTION

Aspects of the present invention provide an electrode for a fuel cell having superior water repellency even when a relatively small amount of binder is used compared to a conventional electrode, resulting in maximized efficiency of a supported catalyst, a method of preparing the same, and a fuel cell employing the same.

According to an aspect of the present invention, there is provided an electrode for a fuel cell, including a catalyst layer including a supporting material, a catalyst, and a binder, wherein the specific surface area of the supporting material is at least 500 m²/g, and wherein the binder includes an amount of fluorinated ethylene propylene copolymer in the range of 0.5 to 50 parts by weight based on 100 parts by weight of the total amount of the supporting material and the catalyst.

According to another aspect of the present invention, there is provided a method of preparing an electrode for a fuel cell, including: preparing a slurry by mixing a supporting material having a specific surface area of at least 500 m²/g, a supported catalyst, a dispersing medium, and an amount of fluorinated ethylene propylene copolymer in the range of 0.5 to 50 parts by weight based on 100 parts by weight of the total amount of the supporting material and the catalyst; coating the slurry on an electrode material and drying the resultant product; and heat treating the dried resultant product.

According to another aspect of the present invention, there is provided a fuel cell employing the electrode described above.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is schematic flowchart illustrating a method of preparing an electrode for a fuel cell according to an embodiment of the present invention;

FIG. 2 is a graph showing current-voltage properties of two membrane electrode assemblies of respective unit cells with respect to the loading amount of a catalyst, each including a hydrophobic coated PTFE electrolyte membrane and an electrode prepared in Example 1 or Comparative Example 1, respectively;

FIG. 3 is a graph showing performance of a cell with respect to the amount of a binder of a unit cell, each unit cell including a hydrophobic coated PTFE electrolyte membrane and an electrode prepared in Examples 2 through 6, respectively; and

FIG. 4 is a graph illustrating long-term durability of a unit cell including a hydrophobic coated PTFE electrolyte membrane and an electrode prepared in Example 4.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An electrode for a fuel cell according to an embodiment of the present invention has excellent water repellency and maintains excellent specific surface area of a supported catalyst to maximize the application of the supported catalyst.

Conventionally, a polytetrafluoroethylene (PTFE) binder is added while preparing an electrode to make the electrode water repellant. However, when the specific surface area of a supporting material is about 500 m²/g or more, even when 50 wt % or more PTFE compared to the weight of the supported catalyst is added, a desired level of water repellency cannot be obtained. Nevertheless, to use an electrolyte membrane having inferior phosphoric acid containability, such as a TEFLON-based electrolyte membrane, in an electrode, water repellency of the electrode should be excellent. Also, when good water repellency of the electrode is obtained, a wider variety of electrode types which can be employed becomes available.

When fluorinated ethylene propylene (FEP) copolymer is used instead of PTFE as the binder in an electrode, a much smaller amount of FEP copolymer, compared to PTFE, can provide water repellency to the electrode which can prevent crossover.

The above is possible because FEP copolymer has superior dispersibility than PTFE. FEP copolymer has superior dispersibility than PTFE because FEP copolymer shows binder properties through melting and thus has efficient and strong adhesion, whereas PTFE shows binder properties through fiberization. Accordingly, the electrode of the current embodiment uses FEP copolymer binder instead of PTFE binder. Hence, even when the specific surface area of the supporting material is 500 m²/g or more, a small amount of binder can be used to provide effective water repellency.

The amount of FEP copolymer may be in a range of 0.5 to 50 parts by weight based on 100 parts by weight of the total amount of a supporting material and a catalyst, i.e., the amount of the supported catalyst, and more preferably, in the range of 20 to 50.

Specifically, when the electrode of the current embodiment is used as an anode, the amount of FEP copolymer may be in a range of 0.5 to 40 parts by weight based on 100 parts by weight of the total amount of the supporting material and the catalyst. When the electrode is used as a cathode, the amount of FEP copolymer may be in a range of 10 to 50 parts by weight based on 100 parts by weight of the total amount of the supporting material and the catalyst.

Generally, when the amount of FEP copolymer is less than the above range, sufficient binding property and water repellency cannot be obtained. Generally, when the amount is greater than the above range, the specific surface area of the supported catalyst is reduced and the cell resistance of the electrode is increased.

The electrode of the current embodiment may further include polytetrafluoroethylene or polyvinylidenefluoride as a constituent of the binder.

Also, the electrode may further include a surfactant, which prevents aggregation of a slurry for manufacturing an electrode and disperses the slurry easily. Preferably, the surfactant may have a hydrophobic moiety and a hydrophilic moiety at the same time to maximize the efficiency of the catalyst. The hydrophobic moiety, although not limited, may include at least one selected from the group consisting of an alkyl group, a perfluoro group, and an aromatic group. The hydrophilic moiety, although not limited, may include at least one selected from the group consisting of an amine group, a hydroxyl group, a phosphate group, and a sulfate group.

The amount of the surfactant may be in a range of 0.1 to 100 parts by weight based on 100 parts by weight of the total amount of the supporting material and the catalyst. Generally, when the amount of the surfactant is less than 0.1 parts by weight, the slurry may not disperse well and aggregate, and as a result, the slurry may be impossible to be coated. When the amount of the surfactant is more than 100 parts by weight, the surfactant may adsorb on the surface of the catalyst, thus reducing the active area of the catalyst. Accordingly, performance of the catalyst deteriorates.

Hereinafter, a method of preparing an electrode for a fuel cell according to an embodiment of the present invention will be described.

The method includes: preparing a slurry by mixing a supporting material having a specific surface area of at least 500 m²/g, a supported catalyst, a dispersing medium, and fluorinated ethylene propylene copolymer at an amount in a range of 0.5 to 50 parts by weight based on 100 parts by weight of the total amount of the supporting material and the catalyst; coating the slurry on an electrode material and drying the resultant product; and heat treating the dried resultant product. FIG. 1 is a schematic flowchart illustrating the method of preparing the electrode for a fuel cell according to the current embodiment of the present invention.

Referring to FIG. 1, the slurry is prepared by mixing the supported catalyst, the dispersing medium, and the FEP copolymer emulsion.

Examples of the supported catalyst according to the current embodiment of the present invention, although not limited, may include platinum (Pt), ruthenium (Ru), palladium (Pd), rhodium (Rh), iridium (Ir), osmium (Os), gold (Au), cobalt (Co), vanadium (V), iron (Fe), tin (Sn), a mixture thereof, an alloy thereof, and the supported catalyst may include any one of the above metals dispersed in carbon black having at least 500 m²/g specific surface area, carbon black such as acetylene black, etc., activated carbon, or graphite. The supported catalyst may be PtRu/C catalyst.

The dispersing medium may be water, 1-propanol, ethyleneglycol, 2-propanol, etc. The amount of the dispersing medium may be in a range of 5 to 250 parts by weight based on 100 parts by weight of the total amount of the supporting material and the catalyst. In detail, when water is used as the dispersing medium, the amount of water may be in a range of 150 to 250 parts by weight. When 1-propanol is used as the dispersing medium, the amount of 1-propanol may be in a range of 5 to 20 parts by weight. When ethyleneglycol is used as the dispersing medium, the amount of ethyleneglycol may be in a range of 5 to 20 parts by weight. When 2-propanol is used as the dispersing medium, the amount of 2-propanol may be in a range of 5 to 20 parts by weight.

The binder of the current embodiment includes FEP copolymer. The amount of the binder may be in the range of 0.5 to 50 parts by weight, preferably 20 to 50 parts by weight based on 100 parts by weight of the total amount of the supporting material and the catalyst. However, when required, the binder may further include polytetrafluoroethylene or polyvinylidenefluoride as a constituent of the binder.

Also, as described above, when the electrode of the current embodiment is used as an anode, the amount of FEP copolymer may be in a range of 0.5 to 40 parts by weight based on 100 parts by weight of the total amount of the supporting material and the catalyst. When the electrode is used as a cathode, the amount of FEP copolymer may be in a range of 10 to 50 parts by weight based on 100 parts by weight of the total amount of the supporting material and the catalyst.

The slurry may further include a surfactant. The surfactant may have a hydrophobic moiety and a hydrophilic moiety at the same time to maximize the efficiency of the catalyst. The hydrophobic moiety, although not limited, may include at least one selected from the group consisting of an alkyl group, a perfluoro group, and an aromatic group. The hydrophilic moiety, although not limited, may include at least one selected from the group consisting of an amine group, a hydroxyl group, a phosphate group, and a sulfate group. The amount of the surfactant may be in a range of 0.1 to 100 parts by weight based on 100 parts by weight of the total amount of the supporting material and the catalyst.

The slurry may further include isopropyl alcohol (IPA) to uniformly spread the constituents of the binder. In particular, when water is used as the dispersing medium, the surfactant and IPA make direct coating of the slurry on the electrode material easy. The amount of IPA may be in a range of 5 to 20 parts by weight based on 100 parts by weight of the total amount of the supporting material and the catalyst.

Subsequently, the slurry is coated on the electrode material. Coating methods are not limited, and any coating method which can be used to form a catalyst layer having uniform thickness on the electrode material can be employed. Examples of coating methods include tape casting, spraying, screen printing, etc., but are not limited thereto. As the electrode material, carbon paper, etc. can be used.

The resultant product is dried, preferably at 300 to 400° C. for 5 min. to 6 hours. Generally, when the temperature is lower than the above range, the dispersing medium may not be removed sufficiently, and so the resultant product may not be dried completely. Generally, when the temperature is higher than the above range, the catalyst may be damaged. Also, when the time is less than the above range, the dispersing medium may not be removed sufficiently, and so the resultant product may not be dried completely. Times greater than the above range, are generally uneconomical.

Finally, the dried resultant product is heat treated to obtain the electrode for a fuel cell according to the current embodiment of the present invention. Preferably, the dried resultant product may be heat treated at 300 to 400° C. for 5 min. to 6 hours with nitrogen.

The heat treating not only removes the dispersing medium, but also uniformly distributes the binder to obtain an optimum level of water repellency and to prevent loss of carbon. When the temperature is lower than the above range, the binder is generally not distributed sufficiently, and so the binder cannot perform its intended role and thus water repellency deteriorates. When the temperature is higher than the above range, the electrode may deform due to excessive heat. Generally, when the time is less than the above range, the binder is not distributed sufficiently, and so the binder cannot perform its intended role and thus water repellency deteriorates. When the time is greater than the above range, it is not only uneconomical, but also the binder is non-uniformly distributed, thus reducing electrode performance.

According to another embodiment of the present invention a fuel cell employing the electrode described above is provided. Electrodes prepared using the above method are connected to respective sides of an electrolyte membrane and diffusers to form a membrane electrode assembly. The membrane electrode assembly, with a separator (or bipolar plate), forms a unit cell. Several to several tens of unit cells are stacked to form the fuel cell. A fuel processor, a fuel tank, a fuel pump, etc., may further be equipped to form a fuel cell system.

The present invention will be described in greater detail with reference to the following examples. The following examples are for illustrative purposes only and are not intended to limit the scope of the invention.

### EXAMPLE 1

### FEP 10 wt %

1 g of 45.8 wt % Pt/Ketjen Black as a supported catalyst was mixed with 2 g of water, 0.2 g of isopropyl alcohol, 0.2 g of surfactant, and 0.2 g of FEP copolymer emulsion as a binder. The resultant mixture was put into a sonic bath and mixed for 2 hours to obtain a slurry. The slurry was coated on a carbon paper as an electrode material, and the resultant product was dried at ambient temperature for 1 hour. Accordingly, the dried resultant product was heat treated at 360° C. for 5 hours with nitrogen to obtain a first electrode of a fuel cell.

### EXAMPLE 2

### FEP 20 wt %

A second fuel cell electrode was prepared in the same manner as in Example 1, except that 0.4 g of FEP copolymer emulsion was used as a binder.

### EXAMPLE 3

### FEP 25 wt %

A third fuel cell electrode was prepared in the same manner as in Example 1, except that 0.5 g of FEP copolymer emulsion was used as a binder.

### EXAMPLE 4

### FEP 30 wt %

A fourth fuel cell electrode was prepared in the same manner as in Example 1, except that 0.6 g of FEP copolymer emulsion was used as a binder.

### EXAMPLE 5

### FEP 40 wt %

A fifth fuel cell electrode was prepared in the same manner as in Example 1, except that 0.8 g of FEP copolymer emulsion was used as a binder.

### EXAMPLE 6

### FEP 25 wt %+PTFE 15 wt %

A sixth fuel cell electrode was prepared in the same manner as in Example 1, except that a mixture of 0.5 g of FEP copolymer emulsion and 0.25 g of PTFE was used as a binder.

### COMPARATIVE EXAMPLE 1

### PTFE 42 wt %

A comparative fuel cell electrode was prepared in the same manner as in Example 1, except that 0.7 g of PTFE was used as a binder.

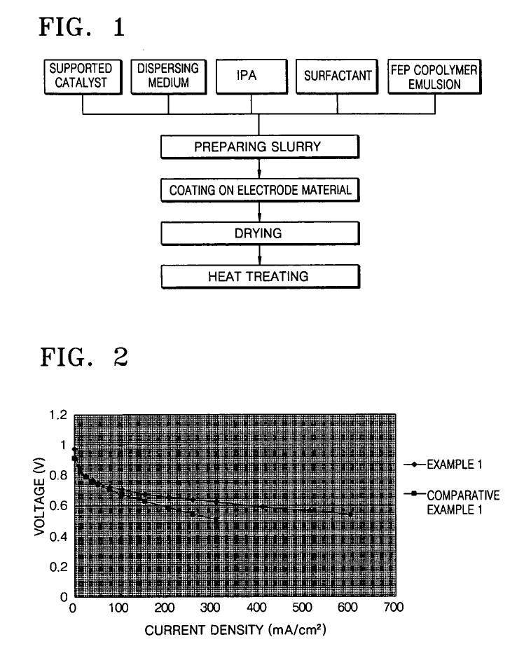

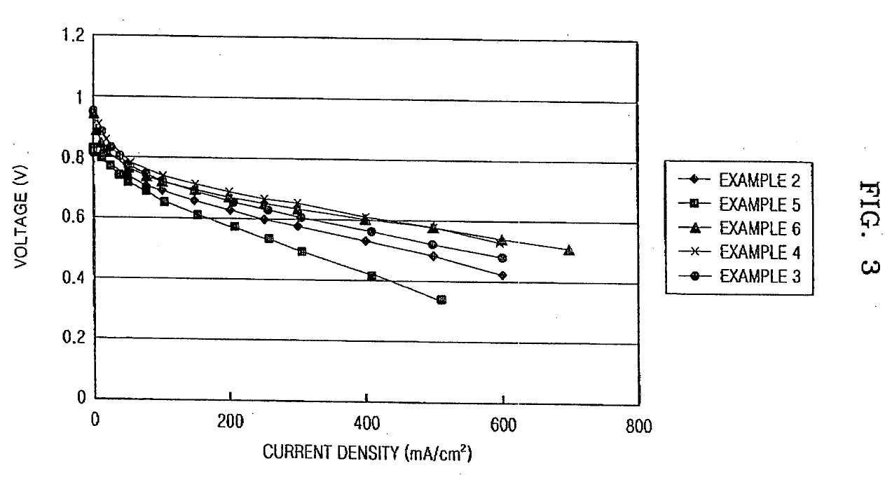

FIG. 2 is a graph comparing current-voltage properties of membrane electrode assemblies with a constant loading amount of a catalyst, of unit cells each including a hydrophobic coated PTFE electrolyte membrane and electrodes prepared in Example 1 or Comparative Example 1, respectively. The measurement conditions were: temperature of 150° C., electrode area of 2.8×2.8 cm, 0.1 L/min of hydrogen, and 0.2 L/min of air.

As shown in FIG. 2, the fuel cell including the electrode prepared in Example 1 had higher voltage than the fuel cell including the electrode prepared in Comparative Example 1 at similar current densities.

FIG. 3 is a graph showing performance of a cell with respect to the amount of a binder of unit cells each including a hydrophobic coated PTFE electrolyte membrane and an electrode prepared in Examples 2 through 6, respectively. The measurement conditions were the same as above.

As shown in FIG. 3, as the amount of FEP copolymer increased, the fuel cell showed higher voltage at the same current density.

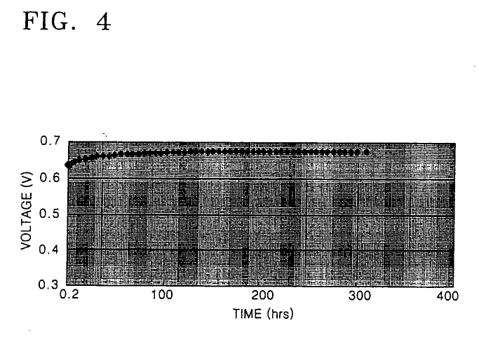

FIG. 4 is a graph illustrating long-term durability of a unit cell including a hydrophobic coated PTFE electrolyte membrane and an electrode prepared in Example 4. The measurement conditions were the same as above and the current was maintained at 300 mA/cm².

As shown in FIG. 4, the fuel cell employing the electrode prepared in Example 4 maintained a stable voltage even after a long time.

The electrode according to aspects of the present invention has superior water repellency even when a relatively small amount of binder is used compared to a conventional electrode, and as a result, efficiency of a supported catalyst is maximized.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel cell electrode, comprising a catalyst layer comprising a supporting material, a catalyst, and a binder, wherein the specific surface area of the supporting material is at least 500 m²/g, and wherein the binder comprises an amount of fluorinated ethylene propylene copolymer in a range of 0.5 to 50 parts by weight based on 100 parts by weight of a total amount of the supporting material and the catalyst.

2. The electrode of claim 1, wherein the binder comprises an amount of fluorinated ethylene propylene copolymer in a range of 20 to 50 parts by weight based on 100 parts by weight of the total amount of the supporting material and the catalyst.

3. The electrode of claim 1, wherein the amount of fluorinated ethylene propylene copolymer is in a range of 0.5 to 40 parts by weight based on 100 parts by weight of the total amount of the supporting material and the catalyst when the electrode is used as an anode.

4. The electrode of claim 1, wherein the amount of fluorinated ethylene propylene copolymer is in a range of 10 to 50 parts by weight based on 100 parts by weight of the total amount of the supporting material and the catalyst when the electrode is used as a cathode.

5. The electrode of claim 1, wherein the binder further comprises polytetrafluoroethylene or polyvinylidenefluoride.

6. The electrode of claim 1, wherein the catalyst layer further comprises a surfactant.

7. The electrode of claim 6, wherein the surfactant has a hydrophobic moiety and a hydrophilic moiety at the same time.

8. The electrode of claim 7, wherein the hydrophobic moiety comprises at least one selected from the group consisting of an alkyl group, a perfluoro group, and an aromatic group; and wherein the hydrophilic moiety comprises at least one selected from the group consisting of an amine group, a hydroxyl group, a phosphate group, and a sulfate group.

9. The electrode of claim 6, wherein the amount of the surfactant is in a range of 0.1 to 100 parts by weight based on 100 parts by weight of the total amount of the supporting material and the catalyst.

10. The electrode of claim 6, further comprising an electrode material to support the catalyst layer.

11. A method of preparing a fuel cell electrode for a fuel cell, comprising:
preparing a slurry by mixing a supporting material having a specific surface area of at least 500 m²/g, a supported catalyst, a dispersing medium, and a binder comprising an amount of fluorinated ethylene propylene copolymer in a range of 0.5 to 50 parts by weight based on 100 parts by weight of a total amount of the supporting material and the catalyst;
coating the slurry on an electrode material and drying the resultant product; and
heat treating the dried resultant product to obtain the fuel cell electrode.

12. The method of claim 11, wherein the amount of the fluorinated ethylene propylene copolymer is in a range of 20 to 50 parts by weight based on 100 parts by weight of the total amount of the supporting material and the catalyst.

13. The method of claim 11, wherein the amount of fluorinated ethylene propylene copolymer is in a range of 0.5 to 40 parts by weight based on 100 parts by weight of the total amount of the supporting material and the catalyst when the electrode is used as an anode.

14. The method of claim 11, wherein the amount of fluorinated ethylene propylene copolymer is in a range of 10 to 50 parts by weight based on 100 parts by weight of the total amount of the supporting material and the catalyst when the electrode is used as a cathode.

15. The method of claim 11, wherein the binder further comprises polytetrafluoroethylene or polyvinylidenefluoride.

16. The method of claim 11 wherein the slurry further comprises a surfactant.

17. The method of claim 16, wherein the surfactant has a hydrophobic moiety and a hydrophilic moiety at the same time.

18. The method of claim 17,
wherein the hydrophobic moiety comprises at least one selected from the group consisting of an alkyl group, a perfluoro group, and an aromatic group; and
wherein the hydrophilic moiety comprises at least one selected from the group consisting of an amine group, a hydroxyl group, a phosphate group, and a sulfate group.

19. The method of claim 16, wherein the amount of the surfactant is in a range of 0.1 to 100 parts by weight based on 100 parts by weight of the total amount of the supporting material and the catalyst.

20. The method of claim 11, wherein the slurry further comprises isopropyl alcohol.

21. The method of claim 20, wherein the amount of isopropyl alcohol is in a range of 5 to 20 parts by weight based on 100 parts by weight of the total amount of the supporting material and the catalyst.

22. The method of claim 11, wherein the drying of the resultant product is performed at 300 to 400° C. for 5 min. to 6 hours.

23. The method of claim 11, wherein the heat treating of the dried resultant product is performed at 300 to 400° C. for 5 min. to 6 hours with nitrogen.

24. A fuel cell comprising the electrode of claim 1.

25. A fuel cell electrode, comprising:
an electrode material to support the electrode;
a catalyst supporting material having a specific surface area of at least 500 m²/g;
a supported catalyst impregnated in the catalyst supporting material;
a binder to bind the catalyst supporting material on the electrode material, wherein the binder comprises fluorinated ethylene propylene copolymer in a range of 0.5 to 50 parts by weight based on 100 parts by weight of a total amount of the catalyst supporting material and the supported catalyst.
